(19) United States
(12) Patent Application Publication
(10) Pub. No.: US 2010/0149674 A1
(43) Pub. Date: Jun. 17, 2010

(54) METHOD OF MANUFACTURING DISK DEVICE, METHOD OF WRITING SERVO INFORMATION TO STORAGE DISK, AND DISK DEVICE

(75) Inventor: Isamu TOMITA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/713,050

(22) Filed: Feb. 25, 2010

Related U.S. Application Data
(63) Continuation of application No. PCT/JP2007/000935, filed on Aug. 30, 2007.

(51) Int. Cl. G11B 27/36; G11B 21/02

(52) U.S. Cl. 360/31; 360/75; G9B/27.052

(57) ABSTRACT

According to one embodiment, a method of writing servo information comprises: moving a head at a predetermined pitch in the radial direction of a storage disk to write servo information to each radial direction position in the circumferential direction of the storage disk; detecting a positional deviation value of the head while the servo information is being written to the radial direction position and determining whether the positional deviation value exceeds a predetermined value; and writing, when the positional deviation value exceeds the predetermined value, the position of defective servo information where the positional deviation value exceeds the predetermined value to a predetermined position in the radial direction of the storage disk.

### CROSS-REFERENCE TO RELATED APPLICATIONS

This application is a continuation of PCT international application Ser. No. PCT/JP2007/000935 filed on Aug. 30, 2007 which designates the United States, incorporated herein by reference.

### BACKGROUND

1. Field

One embodiment of the invention relates to a method of manufacturing a disk device that writes servo information to a storage medium, a method of writing servo information to the storage medium, and a disk device.

2. Description of the Related Art

A disk device, such as a magnetic disk device, moves a head to a desired track of a disk medium such as a magnetic disk and reads data from the track of the disk medium or writes data to the track of the disk medium. Servo information is recorded on the disk medium at predetermined intervals in the circumferential direction of the track. The head reads the servo information, and demodulates the servo information to obtain the positional information of the head.

In recent years, with an improvement in the recording density of the disk medium, the track pitch has been narrowed. Therefore, the servo information is simultaneously written to a plurality of disk media by a high-accuracy dedicated device (for example, a servo track writer) before the media are incorporated in a disk device. Then, one or more media are incorporated in the disk device and then used therein.

As illustrated in FIG. 10, the servo track writer moves the head at a predetermined pitch over a storage medium 10 such as a magnetic disk (hereinafter, “disk medium”). When the disk medium 10 is rotating, the servo track writer concentrically writes a plurality of servo information items (hereinafter, “SV”) (for example, 270 servo frames). The concentric circles are tracks T1 to TN. Since the number of tracks on the disk medium 10 has increased (for example, 10000 tracks or more), the time required to write the servo information has increased. With an increase in the number of tracks and a reduction in track pitch, the number of tracks having an error at the write position of servo information has increased.

In the conventional servo track writer, when a write position error occurs due to instantaneous external vibration, the head returns to a stopper position and retries a write operation. However, when the write operation is retried, it takes a long time to perform a servo track write operation since the number of tracks having servo information errors is increased. Therefore, it is difficult to retry the write operation.

For example, Japanese Patent Application Publication (KOKAI) Nos. 9-198822 and 11-353829 disclose conventional technologies in which, after a disk medium is incorporated in a disk device, a head reads the positional information of servo information, positioning quality is measured, and a track having low positioning quality is skipped without being used.

However, as the track pitch is narrowed, a larger amount of track pitch error that does not appear in positioning quality occurs in a disk medium. As a result, a plurality of data items whose generation are different can be read from the same data sector. It makes data corruption. As illustrated in FIG. 11, when servo information SV of a track T2 is recorded without a position error to form the track T2 and external vibration is applied while the servo information SV of an adjacent track T1 is being written, the servo information of the track T1 is written while deviating from a predetermined position (solid line). As a result, the track pitch is partially changed and the trace of the track T1 has a dotted line shape.

Similarly, when external vibration is applied while the servo information SV of an adjacent track TM is being written, the servo information of the track TM is written while deviating from a predetermined track position (solid line) TM. As a result, all the track pitches are changed, and the trace of the track TM has a dotted line shape.

When the tracks T1 and TM are formed, the servo information SV is normally written in the conventional technology that measures positioning quality at the above device level. Therefore, the head normally reads the servo information, and it is difficult for the head to determine that the positioning quality is low.

Meanwhile, during a data read/write operation, the device controls the head position based on the servo information. In this case, the head does not perform the read/write operation at the exactly same position, but there is a little positional deviation in the read/write operation. Therefore, when write data is overwritten on the tracks T1 and TM, there is a deviation between the position of data that has been previously written and the position of data that is being currently written, and it is difficult to completely overwrite the current data on the previous data (erase the previous data). Even when the current data is overwritten on the previous data, the previous data remains (is read).

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary flowchart of a process of manufacturing a disk device according to an embodiment of the invention;

FIG. 2 is an exemplary diagram of servo information on a disk medium in the embodiment;

FIG. 3 is an exemplary diagram for explaining the storage format of the position of defective servo information in the embodiment;

FIG. 4 is an exemplary diagram of a configuration of a servo track writer in the embodiment;

FIG. 5 is an exemplary flowchart of a process of writing servo information in the embodiment;

FIG. 6 is an exemplary block diagram of a disk device in the embodiment;

FIG. 7 is an exemplary diagram for explaining virtual circle position control in the embodiment;

FIG. 8 is an exemplary diagram for explaining head position control when defective servo information is used in the embodiment;

FIG. 9 is an exemplary diagram for explaining head position control when the defective servo information is neglected in the embodiment;

FIG. 10 is an exemplary diagram for explaining a conventional servo information write process; and

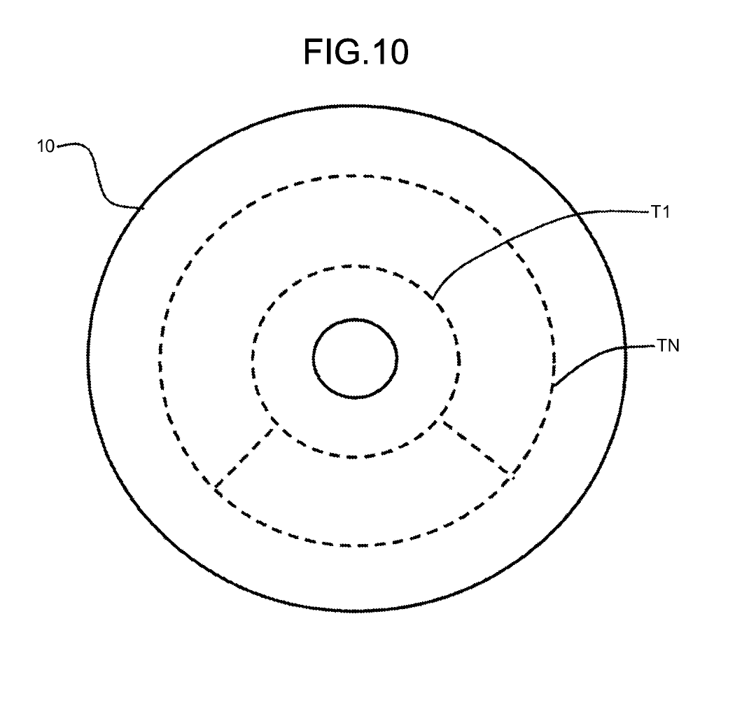

FIG. 11 is an exemplary diagram for explaining head position control by the conventional servo information write process.

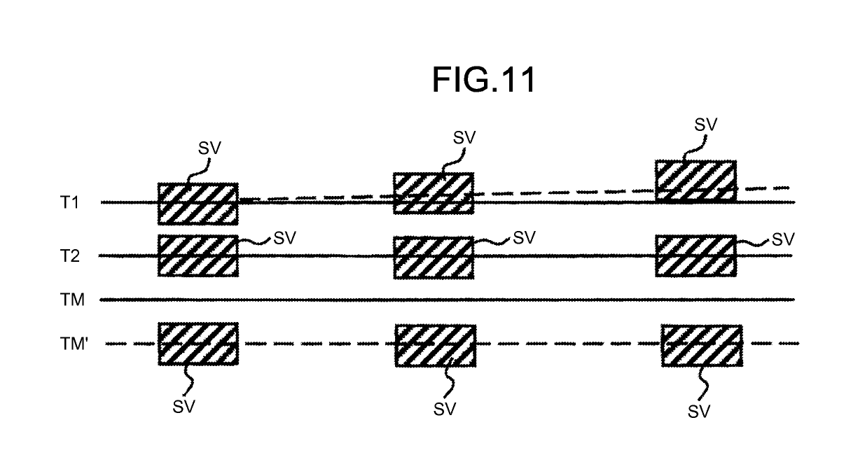

### DETAILED DESCRIPTION

Various embodiments according to the invention will be described hereinafter with reference to the accompanying drawings. In general, according to one embodiment of the invention, there is provided a method of writing servo information. The method comprises: moving a head at a predetermined pitch in the radius direction of a storage disk to write servo information to each radius direction position in the circumferential direction of the storage disk; detecting a positional deviation value of the head while the servo information is being written to the radius direction position and determining whether the positional deviation value exceeds a predetermined value; and writing, when the positional deviation value exceeds the predetermined value, the position of defective servo information where the positional deviation value exceeds the predetermined value to a predetermined position in the radius direction of the storage disk.

According to another embodiment of the invention, there is provided a method of manufacturing a disk device. The method comprises: moving a head at a predetermined pitch in the radius direction of a storage disk to write servo information to each radius direction position in the circumferential direction of the storage disk; detecting a positional deviation value of the head while the servo information is being written to the radius direction position and determining whether the positional deviation value exceeds a predetermined value; writing, when the positional deviation value exceeds the predetermined value, the position of defective servo information where the positional deviation value exceeds the predetermined value to a predetermined position in the radius direction of the storage disk; controlling the head of the disk device to load the position of the defective servo information written to the predetermined position in the radius direction of the storage disk into a memory after the storage disk is incorporated in the disk device; and writing the position of the defective servo information to a control information area of the storage disk to prohibit the use of the defective servo information.

According to still another embodiment of the invention, a disk device comprises a storage disk, a head, an actuator, and a control circuit. Servo information is written to each radius direction position of the storage disk in the circumferential direction thereof. The head is configured to read information from and write information to the storage disk. The actuator is configured to move the head to a predetermined position in the radius direction of the storage disk. The control circuit is configured to detect the position of the head based on the servo information read by the head and control the actuator. The control circuit is configured to move the head at a predetermined pitch in the radius direction of the storage disk to read from the storage disk the position of defective servo information where a positional deviation value of the head exceeds a predetermined value when the servo information is written to each radius direction position in the circumferential direction of the storage disk, and prohibit the use of a track based on the position of the defective servo information.

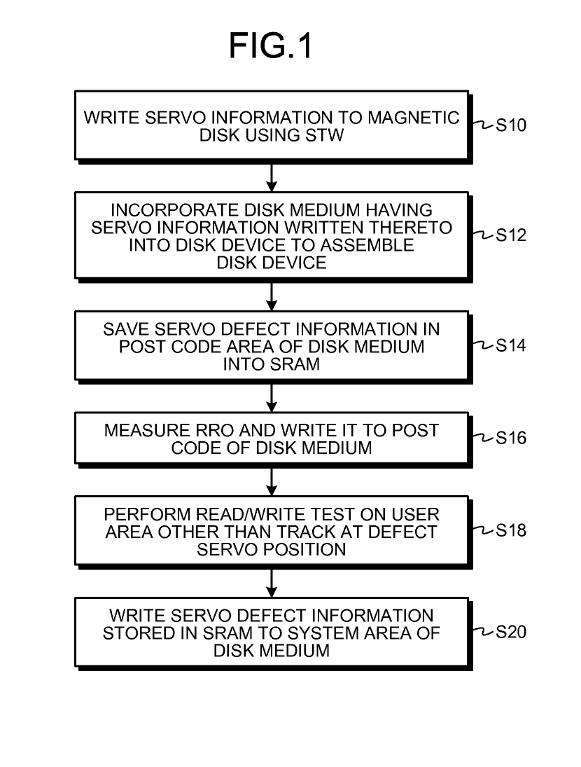

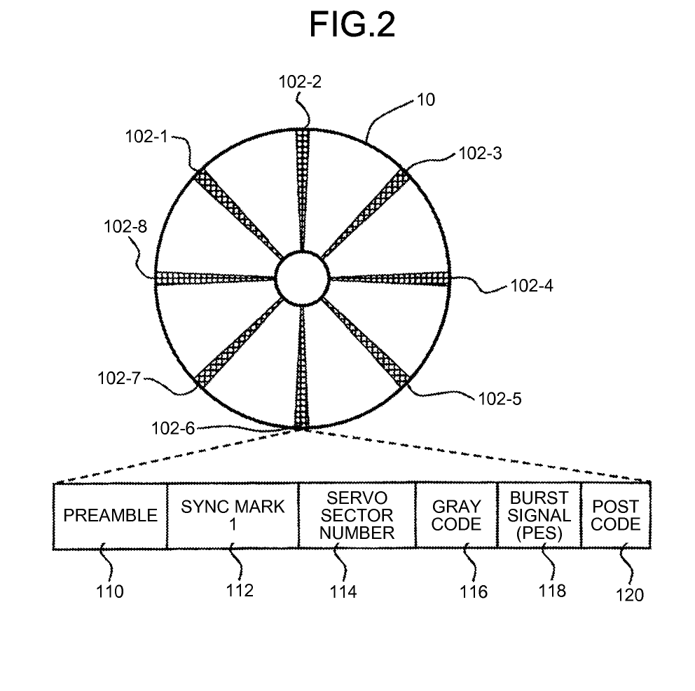

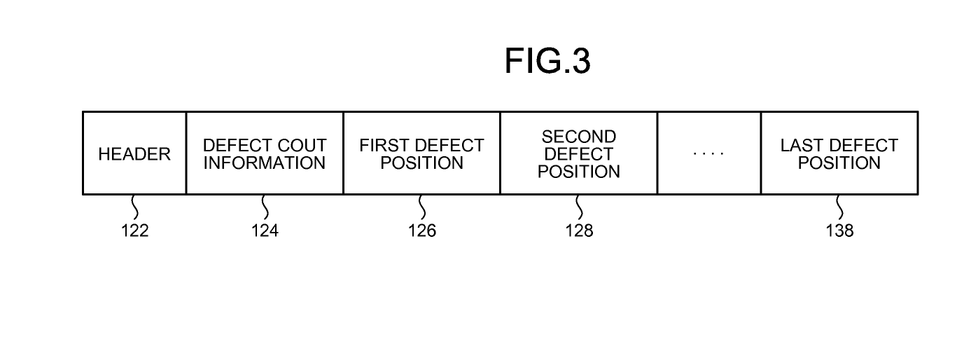

FIG. 1 is a flowchart of a process of manufacturing a disk device according to an embodiment of the invention. FIG. 2 illustrates a disk medium where servo information is written. FIG. 3 is a diagram for explaining the storage format of a position where a position error occurs during a servo track write operation.

The process of manufacturing a disk device will be described with reference to FIGS. 1 to 3.

As illustrated in FIG. 1, a servo track writer 2 writes servo information to the disk medium 10 (S10). As illustrated in FIG. 2, servo information items 102-1 to 102-8 are written to the disk medium 10 at predetermined intervals in the circumferential direction. In a servo track write process, N servo information items 102-1 to 102-8 are written to the disk medium 10 used in a disk device that uses N servo information items (eight servo information items in FIG. 2) along the track.

Each of the servo information items 102-1 to 102-8 comprises a preamble 110 for establishing gain and timing, a sync mark 112 for synchronization control, a servo sector number 114, a gray code 116 indicating a track position, a burst signal 118 as a position error signal (PES) for position control, and a post code 120 that stores repeatable run out (RRO) correction information.

One or a plurality of sectors are arranged between the servo information items 102-1 to 102-8. During a servo write operation, the positional information (information on a position in the radius direction and a distance from an index) of a point where a position error occurs due to, for example, external vibration is stored, and servo information is written to the entire surface of the disk medium. Then, the positional information is written next to the servo information (servo frame) disposed at a predetermined position on the disk medium 10. In this case, servo defect information (positional information) is written to the post code 120 illustrated in FIG. 2 in synchronization with a servo mark of servo information.

When the servo defect information is written to the disk medium 10, positional deviation is likely to occur in a write position due to, for example, heat even when the write position is determined based on a stopper position. Therefore, the width of the disk medium in the radius direction is sufficiently increased and servo information is written to a plurality of tracks in a multiple manner.

Meanwhile, since the write position of the servo information in the circumferential direction (temporal direction) is determined by a clock synchronized with the disk medium 10, the amount of positional deviation from the servo mark is small. Therefore, even when the same data is written to adjacent tracks, it is possible to align the positions of the peaks. Since there is no positional deviation between the peaks, it is possible to exactly read data from the disk medium 10 even when the servo defect information is overwritten to the disk medium 10 while transporting the disk medium at an interval of half of the width of the track.

The servo defect information written in sequence to the servo information is divided and written to each servo frame. For example, as illustrated in FIG. 3, header information 122, defect count information 124 indicating the number of defects, a first defect position 126, a second defect position 128, . . . , last defect information 138 are written in this order from a position corresponding to an index.

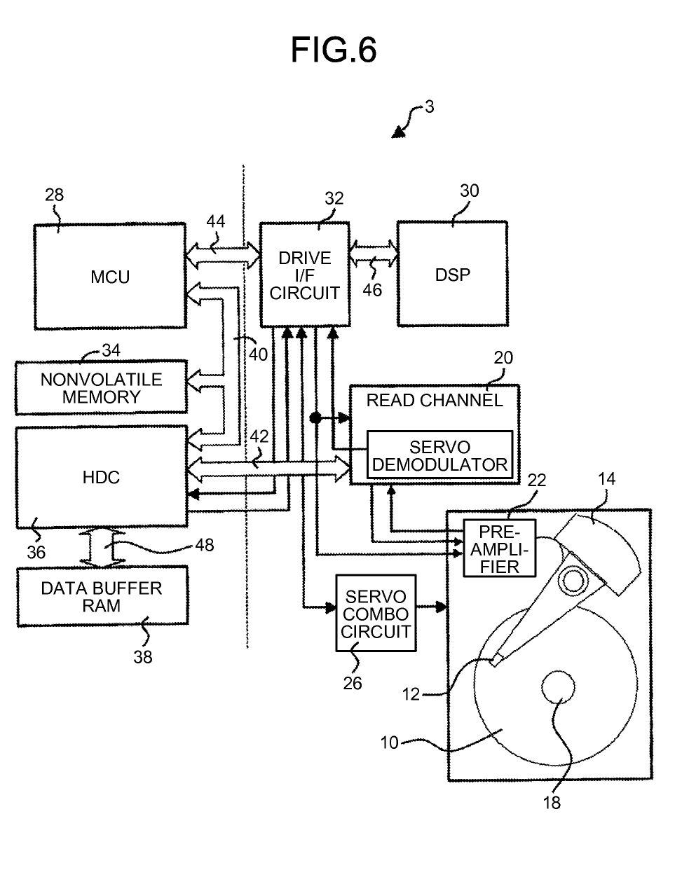

The disk medium 10 to which the servo information and the servo defect information are written in this way is incorporated in a disk device 3 such as a magnetic disk drive, and the disk device 3 is assembled (S12). The disk device 3 will be described in detail with reference to FIG. 6.

In a test after the assembly, the head of the disk device 3 is moved to a track of the disk medium 10 where defect information is written and reads servo defect information written to the post code 120 on the disk medium 10 with the same format as RRO correction data (S14). When the servo defect information is not read, the head is shifted in the radius direction to retry the read operation until the servo defect information is read. The read servo defect information is stored in a nonvolatile memory 34 such as a static random access memory (SRAM) or a flash read only memory (ROM) (see FIG. 6). That is, to write regular RRO correction data to the post code 120, it is necessary to overwrite the RRO correction data on the servo defect information. Therefore, the head is retracted from the disk medium 10.

Then, the disk device 3 measures RRO, and writes it to the post code 120 of the servo information of the disk medium 10 (S16).

Then, the disk device 3 performs a read/write test on a user area other than the defect servo position on the track and performs formatting (S18).

The disk device 3 writes the servo defect information stored in the nonvolatile memory 34 to a system area (for example, an innermost area) of the disk medium 10 (S20).

In this way, the disk device detects the deviation of a write position due to, for example, external vibration while the servo track writer 2 writes the servo information to the disk medium 10, and writes the servo information position to the servo information of the disk medium 10. Then, the disk medium 10 having the servo information and the servo information defect position recorded thereon is mounted on the drive 3, and the drive is assembled. Then, the disk medium is tested. In this case, the drive reads the servo defect information in the servo information of the disk medium 10, and records it to the system area having control information stored therein.

When there is a defect in the servo information, particularly, when there is an error in the positional information, an erroneous voice coil motor (VCM) current flows, which results in the deviation of the next position. However, since the drive 3 can detect the position of defective servo information from the system area of the disk medium 10 in advance, the servo information is neglected. Therefore, it is possible to prevent the deviation of the subsequent position.

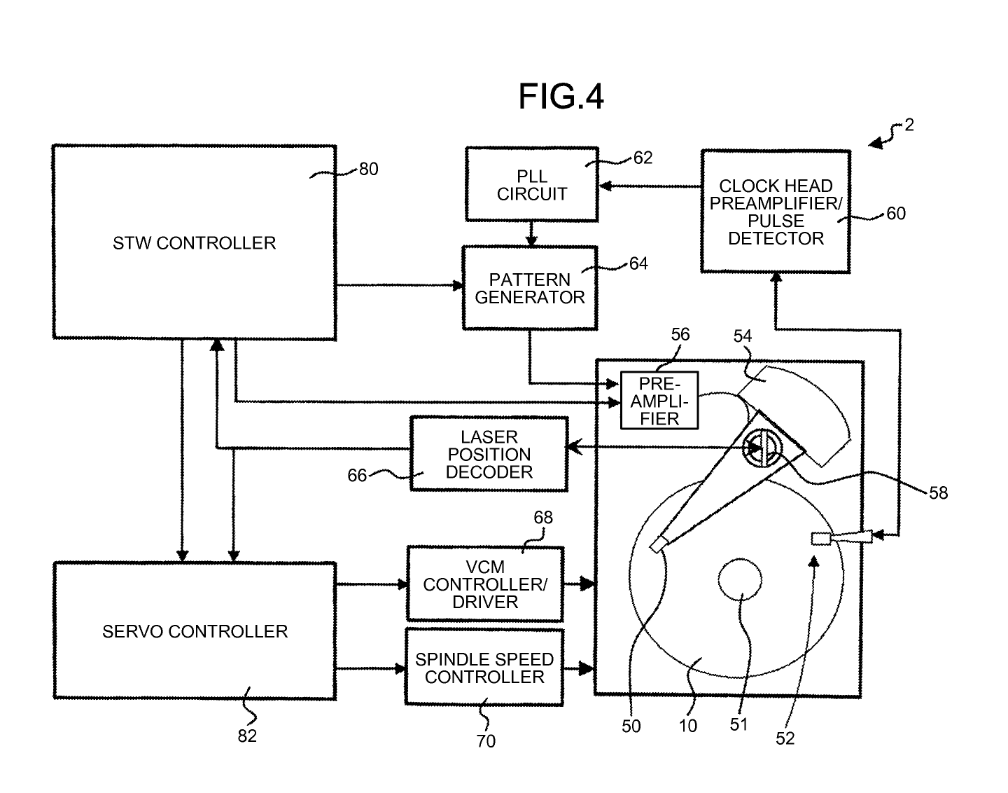

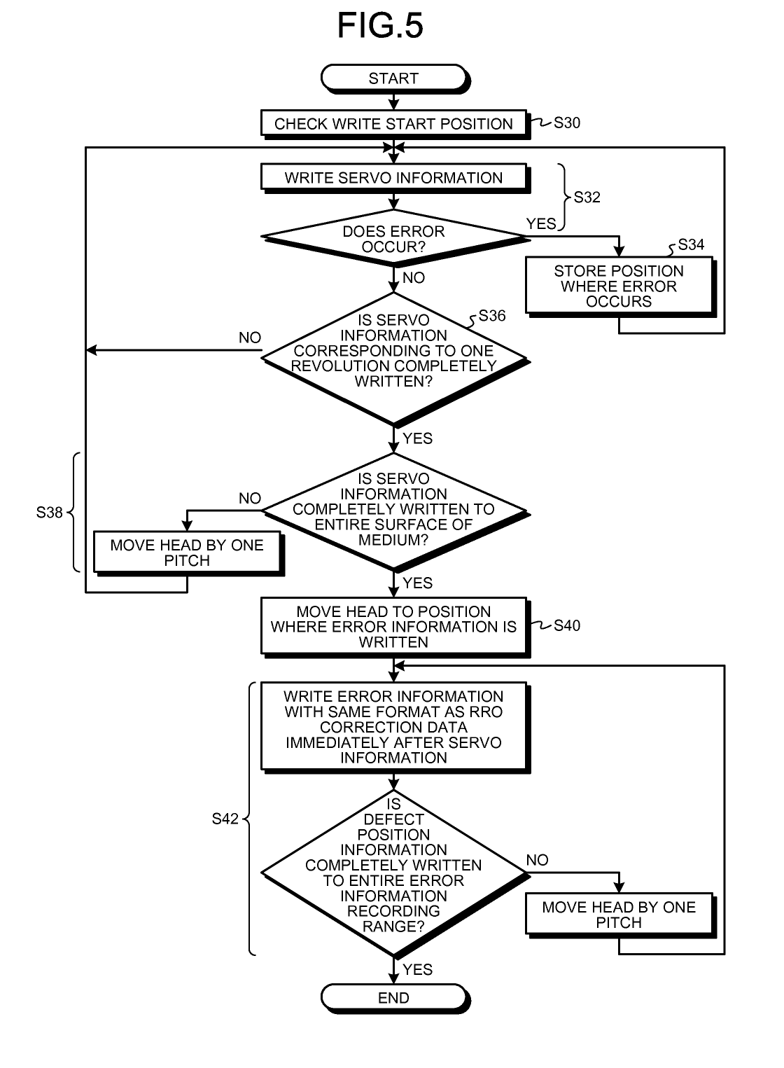

FIG. 4 illustrates a configuration of a servo track writer of the embodiment. FIG. 5 is a flowchart of a servo track writing process by the configuration illustrated in FIG. 4.

As illustrated in FIG. 4, a plurality of the disk media 10 are attached to a rotating shaft 51 of a spindle motor. A VCM (head moving motor) 54 moves a magnetic head 50 provided at the end of an arm thereof in the radius direction of the disk medium 10. A position detecting mirror 58 is provided in the arm of the VCM 54. A clock head 52 writes data to the disk medium 10 at a predetermined frequency and reads the data. A laser position decoder 66 emits laser light to the position detecting mirror 58 attached to the VCM 54 and detects the position of the VCM 54 based on the angle of reflected light.

A clock head preamplifier/pulse detector 60 amplifies the output of the clock head 52 and reproduces a clock synchronized with the rotation of the disk medium 10. A phase locked loop (PLL) circuit 62 generates a clock synchronized with the rotation of the disk medium 10 from the output read from the clock head 52. A pattern generator 64 outputs write data (servo pattern data) to be written to the disk medium 10 according to the clock of the PLL circuit 62. A preamplifier 56 supplies a write current corresponding to the write data output from the pattern generator 64 to the magnetic head 50.

A servo track writer (STW) controller 80 controls the overall operation of the servo track writer 2. A servo controller 82 servo-controls the VCM 54 and controls a spindle speed controller 70 based on the deviation between the position of the actuator from the laser position decoder 66 and the position instructed by the STW controller 80. A VCM controller/driver 68 drives the VCM 54 according to the value of an instruction from the servo controller 82. The spindle speed controller 70 controls the rotational speed of the rotating shaft 51 of the spindle motor.

Next, the operation of the servo track writer 2 will be described. The plurality of magnetic heads 50 are attached to the end of the arm of the VCM 54, and a plurality of target disk media 10 are attached to the rotating shaft 51 of the spindle motor. The magnetic heads 50 face the surfaces of the corresponding disk media 10.

When a servo track write operation starts, the rotating shaft 51 of the spindle motor rotates and thereby the loaded disk media 10 rotates. The PLL circuit 62 generates a clock synchronized with the rotation from the output read from the disk medium 10 by the clock head 52. In addition, the laser position decoder 66 detects the position of the VCM 54 and outputs the detected position to the servo controller 82.

The STW controller 80 controls the servo controller 82 to rotate (servo control) the VCM 54 one pitch by one pitch based on the detected position, thereby moving the magnetic head 50 to a desired position. Then, the STW controller 80 outputs a write servo pattern from the pattern generator 64 to each of the magnetic heads 50 according to a synchronization clock.

Therefore, the servo information items 102-1 to 102-8 illustrated in FIG. 2 are written to each surface of the target disk media 10 with a designated write current. In general, one surface of one disk medium 10 comprises about 100,000 data tracks. Therefore, tracks whose number is 100,000 times the number of servo tracks forming one data track are positioned, and the servo information items 102-1 to 102-8 illustrated in FIG. 2 are written to each track with a designated write current.

After the information items are completely written to all the tracks, the servo track writing process ends. Then, the target disk media 10 are detached from the rotating shaft 51 of the spindle motor. In this way, the disk medium illustrated in FIG. 2 to which servo information is written is created.

During the servo track write operation, the STW controller 80 performs the process illustrated in FIG. 5 to detect a write position error in the radius direction from the output of the laser position decoder 66, thereby specifying the position.

Next, the servo track writing process will be described with reference to FIG. 5.

The STW controller 80 checks a write start position (a start position on the disk medium 10 in the radius direction) from the output of the laser position decoder 66 (S30).

The STW controller 80 instructs the pattern generator 64 to write servo information. Then, the magnetic head 50 writes the servo information to the position in the radius direction determined by the VCM 54. The STW controller 80 monitors the position detected by the laser position decoder 66 while the servo information is being written, and detects whether the positional deviation in the radius direction is equal to or more than a threshold value (off-track threshold value). If the detected position deviation is equal to or more than the threshold value, the STW controller 80 determines that a servo write position error occurs (S32).

If it is determined that a servo write position error occurs (Yes at S32), the STW controller 80 stores as defect information the position where the error occurs (a track address indicating the position in the radius direction (generally, a gray code) and a distance from the index of the disk medium 10) in its memory (S34). Then, the process returns to S32.

The STW controller 80 determines whether servo information corresponding to one revolution of the disk medium 10 is completely written (S36). If it is determined that the servo information is not completely written (No at S36), the process returns to S32.

If it is determined that the servo information corresponding to one revolution of the disk medium 10 is completely written (Yes at S36), the STW controller 80 determines whether the servo information is completely written to the entire surface (the number of desired tracks) of the disk medium 10 (S38). If it is determined that the servo information is not completely written to the entire surface of the disk medium 10 (No at S38), the STW controller 80 issues a position instruction to the servo controller 82 to move the head by one pitch. The servo controller 82 controls the VCM 54 to move the magnetic head 50 in the radius direction by one pitch. Then, the process returns to S32.

If it is determined that the servo information is completely written to the entire surface of the disk medium 10 (Yes at S38), the STW controller 80 moves the magnetic head 50 to a position where error information is written on the disk medium 10 (S40). That is, the STW controller 80 issues a position instruction to the servo controller 82 to move the head to the write position. Then, the servo controller 82 controls the VCM 54 to move the magnetic head 50 to the error information write position in the radius direction.

The STW controller 80 reads the information on the position where an error occurs stored in the memory. Then, the read information is amplified by the preamplifier 56 and the amplified information is written next to the servo information (servo frame) of the disk medium 10 by the magnetic head 50. In this case, servo defect information (positional information) is written to the post code 120 illustrated in FIG. 2 in synchronization with the servo mark of the servo information. In addition, servo defect information written in sequence to the servo information is divided and written to each servo frame. Then, it is determined whether the entire defect position information illustrated in FIG. 3 is completely written to servo information corresponding to one revolution of the disk medium 10 (S42). If it is determined that the entire defect position information is not completely written (No at S42), the STW controller 80 moves the magnetic head 50 in the radius direction by one pitch. Then, similarly, the STW controller 80 writes the remaining defect position information and the process ends.

In this manner, the STW controller 80 monitors the position of the magnetic head 50 while servo information corresponding to one revolution of the disk medium is being written. When the detected amount of positional deviation of the magnetic head is more than a permitted value due to, for example, external vibration, the STW controller 80 stores the position of the magnetic head in the radius direction and a distance from the index as defect servo position information in the memory.

Then, even when the disk medium 10 is incorporated in the drive, the STW controller 80 writes the defect servo position information into the servo information at a specific position in the radius direction such that the defect servo position is read. During a servo track write operation, no information is written to the post code. Therefore, it is possible to write the defect servo position with servo track write clock and frequency by storing the post code. In addition, the drive can read the defect servo position written to the disk medium 10 with servo information read clock and frequency.

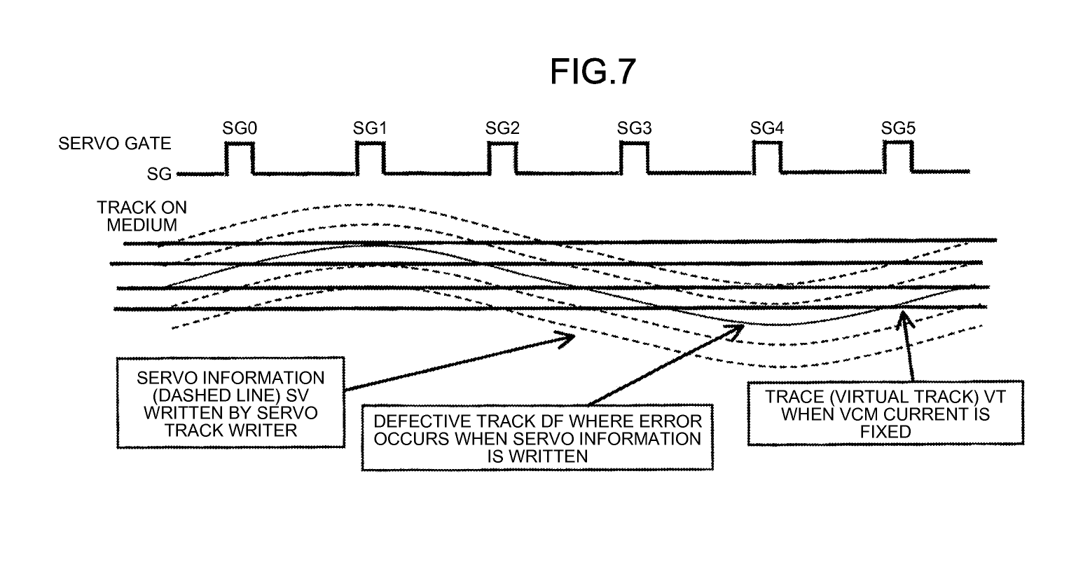

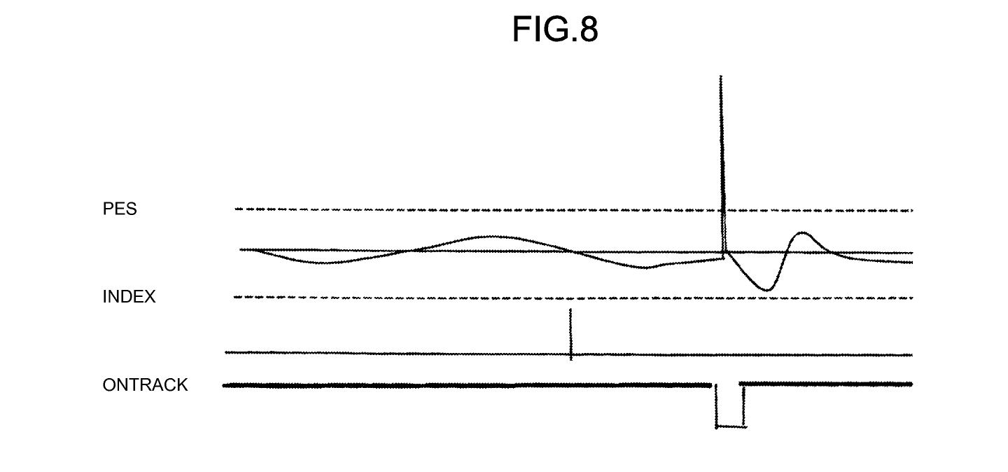

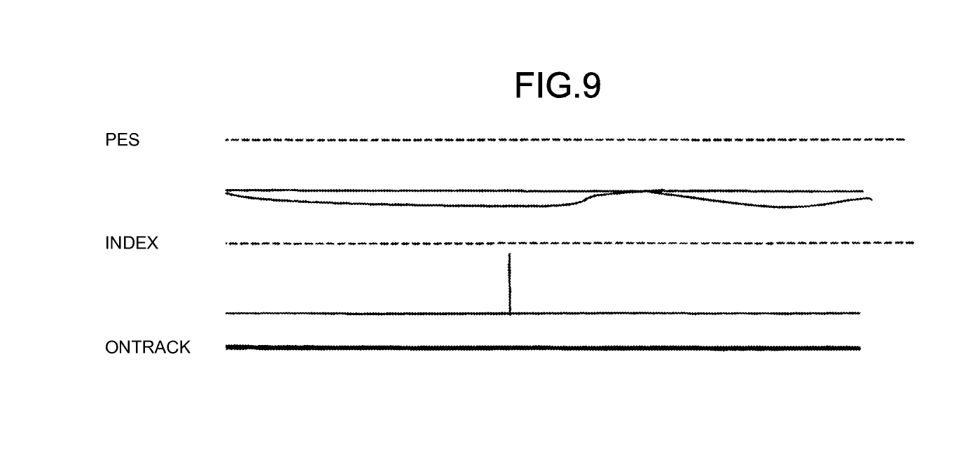

FIG. 6 is a diagram of a disk device in the embodiment. FIG. 7 is a diagram illustrating the virtual circle control. FIGS. 8 and 9 are diagrams illustrating position control based on the defect servo position information. FIG. 6 illustrates a magnetic disk device. As illustrated in FIG. 6, the disk medium 10, which is a magnetic storage medium, is provided at a rotating shaft 19 of a spindle motor 18. The disk medium 10 has servo information and a defect servo position written thereto by the above-mentioned servo track writer 2 and is incorporated with the spindle motor 18 of the drive. The spindle motor 18 rotates the disk medium 10. An actuator (VCM) 14 has a magnetic head 12 at the end thereof and moves the magnetic head 12 in the radius direction of the disk medium 10.

The actuator 14 includes a VCM that rotates about a rotating shaft. In this example, two disk media 10 are loaded to the magnetic disk device, and four magnetic heads 12 are simultaneously driven by the same actuator 14.

The magnetic head 12 comprises a read element and a write element. The magnetic head 12 is formed by sequentially laminating a read element formed of a magneto-resistive (MR) element and a write element formed of a write coil on a slider.

A preamplifier 22 transmits a write current to the magnetic head 12 and amplifies the signal read by the magnetic head 12. A switched virtual circuit (SVC) or a servo combo circuit 26 drives the spindle motor 18 and supplies a driving current to the VCM 14 to drive the VCM 14.

A read channel 20 demodulates the position of the magnetic head 12 from a servo signal among the read signals output from the preamplifier 22. A controller comprises a micro controller (MCU) 28, a digital signal processor (DSP) 30, and a drive interface (I/F) circuit 32.

The DSP 30 detects the current position from the position demodulated by the read channel 20, and calculates a VCM driving instruction value based on the difference between the detected current position and a target position. That is, the DSP 30 performs servo control including seeking and following.

The MCU 28 comprises an MPU, a ROM, and a RAM. The read only memory (ROM) stores, for example, control programs of the MPU, and the random access memory (RAM) stores, for example, data for the process of the MPU. For example, the MCU 28 performs a process of invalidating position control based on the defect servo position, which will be described below.

The drive I/F circuit 32 forms a bridge between a drive-side circuit (the read channel 20, the preamplifier 22, and the servo combo circuit 26), and the MCU 28 and the DSP 30. The drive I/F circuit 32 is connected to the MCU 28 through a first internal bus 44 and is connected to the DSP 30 through a second internal bus 46.

The nonvolatile memory 34 stores a boot program, such as micro codes. A hard disk controller (HDC) 36 determines a position on the disk medium during one revolution based on the sector number of the servo signal, and instructs the read channel 20 to record or reproduce data.

A data buffer random access memory (RAM) 38 is connected to the HDC 36 through a memory bus 48 and temporarily stores read data or write data. The HDC 36 communicates with a host through an interface, such as universal serial bus (USB), advanced technology attachment (ATA) or small computer system interface (SCSI). A bus 40 connects the MCU 28, the nonvolatile memory 34, and the HDC 36. In addition, the HDC 36 is connected to the read channel 20 through a data bus 42 to exchange the read and write data.

The HDC 36 communicates data with the host or the drive. The DSP 30 performs seeking and following control on the magnetic head 12. The MCU 28 controls each module according to commands received by the HDC 36.

As described above, the MCU 28 controls the magnetic head 12 of the disk device 3 to be moved to a track of the disk medium 10 in which defect information is written, and to read the servo defect information that is written to the post code 120 on the disk medium 10 with the same format as the RRO correction data. When the servo defect information is not read, the head is shifted in the radius direction to retry the read operation until the servo defect information is read. The read servo defect information is stored in the nonvolatile memory 34.

The MCU 28 of the disk device 3 measures the RRO of a target data track, calculates a correction value for correcting the RRO, and writes the correction value to the post code 120 of the servo information of the disk medium 10. The MCU 28 of the disk device 3 writes the defect servo position information stored in the nonvolatile memory 34 to a system area (for example, the innermost area) of the disk medium 10. The data written to the post code 120 may be the measured RRO value. Then, the MCU 28 of the disk device 3 performs a read/write test on a user area other than the track at the defect servo position and performs formatting.

Next, the head position control of the disk device 3 based on the defect servo position information will be described. When the servo track writer 2, which is a dedicated device, writes servo information to a disk medium and the disk medium is loaded to the disk device, positional information is changed into a primary sine wave shape due to the deviation between the center of the written servo information and the rotation center of the disk medium 10, which is called eccentricity.

When the VCM and the magnetic head are controlled to follow the sine wave, a current needs to flow through the VCM all the time during track following, which is not preferable in terms of power consumption and the abrasion of a mechanism. In addition, since the amplitude and phase of the primary change (RRO) greatly depend on the kind of media, it takes a long time to center the head when the head is changed. As illustrated in FIG. 7, a control method of following the magnetic head 12 to a virtual track VT having the rotation center of the disk medium 10 as its center (virtual circle control) is used to reduce power consumption or the time required to center the head.

In the virtual circle control, a head track (virtual track) having a fixed VCM current traverses a track SV defined by the servo information of a plurality of media to read the servo information.

In this case, as illustrated in FIG. 8, the position error PES of the DSP 30 becomes large when the current position demodulated from defective servo information is used. As a result, it is determined that an off-track occurs. Meanwhile, as illustrated in FIG. 9, when the position error PES is calculated without considering the defective servo information, the position error PES does not become large.

In the conventional technology, defective tracks SV are all used as data tracks, and as the positional deviation between the center of servo information and the rotation center of the disk medium 10 is increased, the number of virtual tracks VT traversing the defective tracks SV is increased. That is, the use of all the virtual tracks VT traversing the defective tracks SV is prohibited. For example, several hundreds of virtual tracks VT traverse one defective track SV.

As described above, according to the embodiment, the defect position (servo frame position) of the defective servo information is determined in advance. Thus, it is possible to prohibit of the use of only the virtual track from which defective servo information is read. For example, in FIG. 7, when four virtual tracks VT traverse a defective track DF, the use of the four virtual tracks is prohibited in the conventional technology. In this case, however, the use of only the virtual track (for example, one virtual track) from which the servo information of the defect position of the defective track DF is read is prohibited. Therefore, it is possible to improve the use efficiency of a disk medium.

For example, the MCU 28 reads the defect servo position of the system area of the disk medium 10, calculates a servo information track traversed by each virtual circle track and the position of the servo information used from the amount of eccentricity of the virtual circle track, compares it with the above-mentioned defect servo position to determine a virtual circle track that will be prohibited from being used, and prohibits the use of the virtual circle track.

In the above embodiment, while a magnetic disk is used as the disk medium, the disk medium may be other storage media for storing servo information. Besides, the servo information may be written after a disk medium is incorporated in a disk device using, for example, STW or self-servo writing. In addition, the test of the drive 3 may be conducted by a dedicated test device connected to the drive 3.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of writing servo information, comprising:
moving a head at a predetermined pitch in a radial direction of a storage disk in order to write servo information to each radial direction position in a circumferential direction of the storage disk;
detecting a positional deviation value of the head while the servo information is being written to the radial direction position and determining whether the positional deviation value exceeds a predetermined value; and
writing a position of defective servo information where the positional deviation value exceeds the predetermined value to a predetermined position in the radial direction of the storage disk when the positional deviation value exceeds the predetermined value.

2. The method of claim 1, further comprising writing the position of the defective servo information in an area where the servo information has been written in the storage disk.

3. The method of claim 1, further comprising:
storing the position of the defective servo information in a memory each time it is detected that the positional deviation value of the head exceeds the predetermined value; and
reading the position of the defective servo information from the memory in order to write the position of the defective servo information to a predetermined position in the radial direction of the storage disk after the servo information is written to an entire surface of the storage disk.

4. The method of claim 2, further comprising writing the position of the defective servo information in a post code area configured to store an eccentricity amount of the servo information or an eccentricity correction value.

5. The method of claim 2, further comprising writing the position of the defective servo information in the area of the servo information in synchronization with a servo mark of the servo information.

6. The method of claim 1, further comprising writing the position of the defective servo information in the radial direction and in the circumferential direction.

7. A method of manufacturing a disk device, comprising:
moving a head at a predetermined pitch in a radial direction of a storage disk in order to write servo information to each radial direction position in a circumferential direction of the storage disk;
detecting a positional deviation value of the head while the servo information is being written to the radial direction position and determining whether the positional deviation value exceeds a predetermined value;
writing a position of defective servo information where the positional deviation value exceeds the predetermined value to a predetermined position in the radial direction of the storage disk when the positional deviation value exceeds the predetermined value;
controlling the head of the disk device to load the position of the defective servo information written to the predetermined position in the radial direction of the storage disk into a memory after the storage disk is incorporated in the disk device; and
writing the position of the defective servo information to a control information area of the storage disk in order to prohibit using the defective servo information.

8. The method of claim 7, further comprising writing the position of the defective servo information in an area where the servo information has been written in the storage disk.

9. The method of claim 7, further comprising:
storing the position of the defective servo information in the memory each time it is detected that the positional deviation value of the head exceeds the predetermined value; and
reading the position of the defective servo information from the memory in order to write the position of the defective servo information to a predetermined position in the radial direction of the storage disk after the servo information is written to an entire surface of the storage disk.

10. The method of claim 8, further comprising writing the position of the defective servo information in a post code area configured to store an eccentricity amount of the servo information or an eccentricity correction value.

11. The method of claim 8, further comprising writing the position of the defective servo information in the area of the servo information in synchronization with a servo mark of the servo information.

12. The method of claim 10, further comprising:
measuring the eccentricity amount for each track of the storage disk; and
writing the eccentricity amount or the eccentricity correction value to the post code area of the servo information.

13. The method of claim 8, further comprising writing the position of the defective servo information in the radial direction and in the circumferential direction.

14. A disk device comprising:
a storage disk configured to store servo information in each radial direction position in a circumferential direction of the storage disk;
a head configured to read information from and write information to the storage disk;
an actuator configured to move the head to a predetermined position in a radial direction of the storage disk; and
a controller configured to detect a position of the head based on the servo information read by the head and to control the actuator, wherein
the controller is configured to move the head at a predetermined pitch in the radial direction of the storage disk in order to read from the storage disk a position of defective servo information where a positional deviation value of the head exceeds a predetermined value when the servo information is written to each radial direction position in the circumferential direction of the storage disk, and to prohibit using a track based on the position of the defective servo information.

15. The disk device of claim 14, wherein the controller is configured to control the head in order to read the position of the defective servo information written to a control information area of the storage disk.

16. The disk device of claim 14, further comprising a servo track writer configured to write the servo information to each radial direction position in the circumferential direction and the position of the defective servo information to a predetermined position in the radial direction of the storage disk.

17. The disk device of claim 14, wherein the controller is configured to execute virtual circle control of the head around a rotating shaft of the storage disk based on an eccentricity amount of the servo information measured, and to set a virtual track prohibited to be used in the virtual circle control based on the position of the defective servo information.

18. The disk device of claim 17, wherein the controller is configured to prohibit the use of the virtual track traversing the defective servo information.

19. The disk device of claim 14, wherein the controller is configured to read the position of the defective servo information in the radial direction and the circumferential direction from the storage disk, and prohibit the use of the track based on the position of the defective servo information in the radial direction and the circumferential direction.

20. The disk device of claim 14, wherein
the storage disk is a magnetic disk, and
the head is a magnetic head.
